(19) United States
(12) Patent Application Publication
(10) Pub. No.: US 2010/0220789 A1
(43) Pub. Date: Sep. 2, 2010

(54) COMBINED SPATIAL AND BIT-DEPTH SCALABILITY

(76) Inventors: Wu Yuwen, Beijing (CN); Yong Ying Gao, Beijing (CN); Peng Yin, Ithaca, NY (US); Jiancong Luo, Plainsboro, NJ (US)

Correspondence Address: Robert D. Shedd, Patent Operations;THOMSON Licensing LLC, P.O. Box 5312, Princeton, NJ, 08543-5312, US

(21) Appl. No.: 12/734,211

(22) PCT Filed: Oct. 17, 2008
(86) PCT No.: PCT/US08/11901

§ 371 Date: Apr. 19, 2010

Related U.S. Application Data
(60) Provisional application No. 60/999,569, filed on Oct. 19, 2007.

(51) Int. Cl. H04N 7/32; G06K 9/36

(52) U.S. Cl. 375/240.16; 375/240.12; 382/238; 375/E07.243

(57) ABSTRACT

Various implementations are described. Several implementations relate to combined scalability. One method is for encoding a combined spatial and bit-depth scalability. The method includes encoding a source image of a base layer macroblock. The method also includes and encoding a source image of an enhancement layer macroblock by performing an inter-layer prediction. The source image of the base layer and the source image of the enhancement layer differ from each other both in spatial resolution and color bit-depth.

### CROSS REFERENCE TO RELATED APPLICATIONS

This application claims the benefit of U.S. Provisional Application No. 60/999,569, filed on Oct. 19, 2007, titled “Bit-Depth Scalability”, the contents of which are hereby incorporated by reference in their entirety for all purposes.

### TECHNICAL FIELD

Implementations are described that relate to coding systems. Particular implementations relate to bit-depth scalable coding and/or spatial scalable coding.

### BACKGROUND

In recent years, digital images and videos with color bit depth higher than 8-bit are being deployed in many video and image applications. Such applications include, for example, medical image processing, digital cinema workflows in production and postproduction, and home theatre related applications. A bit-depth is the number of bits used to represent the color of a single pixel in a bitmapped image or a video frame. Bit-depth scalability is a solution that is practically useful to enable the co-existence of conventional 8-bit depth and higher bit depth digital imaging systems in the marketplace. For example, a video source can render a video stream having 8-bit depth and 10-bit depth. The bit depth scalability enables two different video sinks (e.g., displays) each having different bit depth capabilities to decode such a video stream.

### SUMMARY

According to a general aspect, a source image of a base layer macroblock is encoded. A source image of an enhancement layer macroblock is encoded by performing inter-layer prediction. The source image of the base layer and the source image of the enhancement layer differ from each other both in spatial resolution and color bit-depth.

According to another general aspect, a source image of a base layer macroblock is decoded. A source image of an enhancement layer macroblock is decoded by performing an inter-layer prediction. The source image of the base layer and the source image of the enhancement layer differ from each other both in spatial resolution and color bit-depth.

According to another general aspect, a portion of an encoded image is accessed and decoded. The decoding includes performing spatial upsampling of the accessed portion to increase the spatial resolution of the accessed portion. The decoding also includes performing bit-depth upsampling of the accessed portion to increase the bit-depth resolution of the accessed portion.

The details of one or more implementations are set forth in the accompanying drawings and the description below. Even if described in one particular manner, it should be clear that implementations may be configured or embodied in various manners. For example, an implementation may be performed as a method, or embodied as apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 is a block diagram of an encoder for encoding combined spatial and bit-depth scalability using an interlayer prediction implemented for intra coding.

FIG. 2 is a block diagram of an interlayer prediction module of an encoder implemented for intra coding.

FIG. 3 is a block diagram of a decoder for decoding a combined bit depth and spatial scalability using an interlayer prediction implemented for intra coding.

FIG. 4 is a block diagram of an interlayer prediction module of a decoder implemented for intra coding.

FIG. 5 is block diagram of an encoder for encoding combined spatial and bit-depth scalability using interlayer residual prediction implemented for inter coding.

FIG. 6 is a block diagram of an interlayer residual prediction module implemented for inter coding.

FIG. 7 is a block diagram of a decoder for decoding a combined spatial and bit-depth scalability using interlayer residual prediction implemented for inter coding.

FIG. 8 is a flowchart describing an encoding method for combined spatial and bit-depth scalability.

FIG. 9 is a flowchart describing a decoding method for combined spatial and bit-depth scalability.

FIG. 10 is a block diagram a video transmitter.

FIG. 11 is a block diagram a video receiver.

FIG. 12 is a block diagram of another implementation of an encoder.

FIG. 13 is a block diagram of another implementation of a decoder.

FIG. 14 is a flow chart of an implementation of a decoding process for use in either a decoder or an encoder.

### DETAILED DESCRIPTION OF AN IMPLEMENTATION

Several techniques are discussed below to handle the coexistence of an 8-bit bit-depth and a higher bit depth (and in particular 10-bit video). Certain embodiments include a method for encoding data such that the encoding has combined spatial and bit-depth scalability. Certain embodiments also include a method for decoding such an encoding.

One of the techniques includes transmitting only a 10-bit coded bit-stream where the 8-bit representation for standard 8-bit display devices is obtained by applying a tone mapping method to the 10-bit presentation. Another technique for enabling the co-existence of 8-bit and 10-bit includes transmitting a simulcast bit-stream that contains an 8-bit coded presentation and a 10-bit coded presentation. The decoder selects which bit-depth to decode. For example, a 10-bit capable decoder can decode and output a 10-bit video while a normal decoder supporting only 8-bit data can output an 8-bit video.

The first technique transmits 10-bit data and is, therefore, not compliant with H.264/AVC 8-bit profiles. The second technique is compliant to all the current standards but it requires additional processing.

A tradeoff between the bit reduction and backward compatibility is a scalable solution. The scalable extension of H.264/AVC (hereinafter “SVC”) supports bit depth scalability. A bit-depth scalable coding solution has many advantages over the techniques described above. For example, such a solution enables 10-bit depth to be backward-compatible with AVC High Profiles and further enables the adaptation to different network bandwidths or device capabilities. The scalable solution also provides low complexity and high efficiency and flexibility.

The SVC bit depth solution supports temporal, spatial, and SNR scalability, but does not support combined scalability. The combined scalability refers to combining both spatial and bit-depth scalability, i.e., the different layers of a video frame or image would be different from each other in both spatial resolution and color bit-depth. In one example, the base layer is 8-bit depth and standard definition (SD) resolution, and the enhancement layer is 10-bit depth and high definition (HD) resolution.

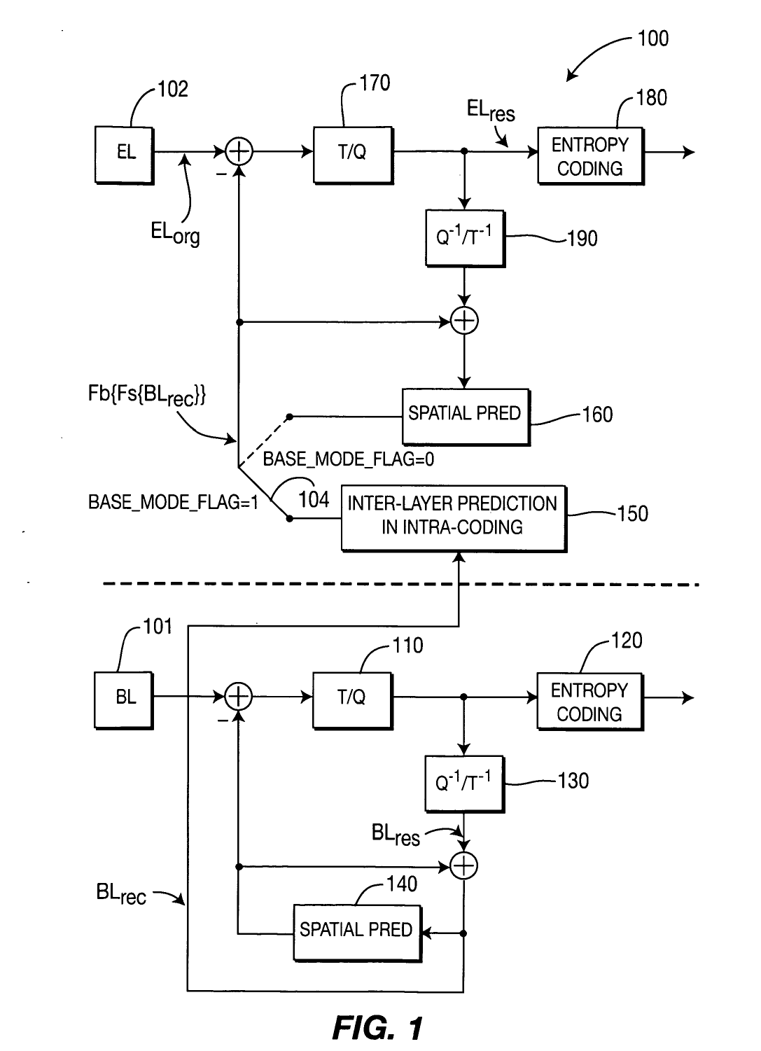

Certain embodiments provide a solution that enables the bit-depth scalability to be fully compatible with the spatial scalability. FIG. 1 shows a non-limiting block diagram of an implementation of an encoder 100 for encoding combined spatial and bit-depth scalability using an interlayer prediction. The encoder 100 is utilized when a collocated base layer macroblock is intra-coded. The encoder 100 receives two source images 101 and 102 of a base layer (BL) and an enhancement layer (EL) respectively. The base and enhancement layers have at least different bit-depth and resolution properties. For example, the base layer has a low bit depth and low spatial resolution while the enhancement layer has a high bit depth and high spatial resolution. To encode the BL bit stream 101, first the spatial prediction of the current block, as computed by the spatial prediction module 140, is subtracted from the source image 101. The difference is transformed and quantized using a transformer and quantizer module 110 and then coded using an entropy coding module 120. The output of the module 110 is inverse quantized and inverse transformed by a module 130 to generate a reconstructed base layer residual signal BLᵣₑₛ. The signal BLᵣₑₛ is then added to the output of the spatial prediction module 140 to generate a collocated base layer macroblock BL_{rec}.

The EL source image 102 may be encoded using an output of the interlayer prediction module 150 or by just performing spatial prediction using a model 160. The operational mode is determined by the state of switch 104. The state of the switch 104 is an encoder decision determined by a rate-distortion optimization process, which chooses a state that has higher coding efficiency. Higher coding efficiency means lower cost. Cost is a measure that combines the bit rate and distortion. Lower bit rate for the same distortion or lower distortion with the same bit rate means lower cost.

The interlayer prediction module 150 computes the prediction of the current enhancement layer by spatial and bit depth upsampling the BL_{rec}. Also shown in FIG. 1 is entropy coding module 180, inverse quantize and inverse transform module 190, and transform and quantize module 170.

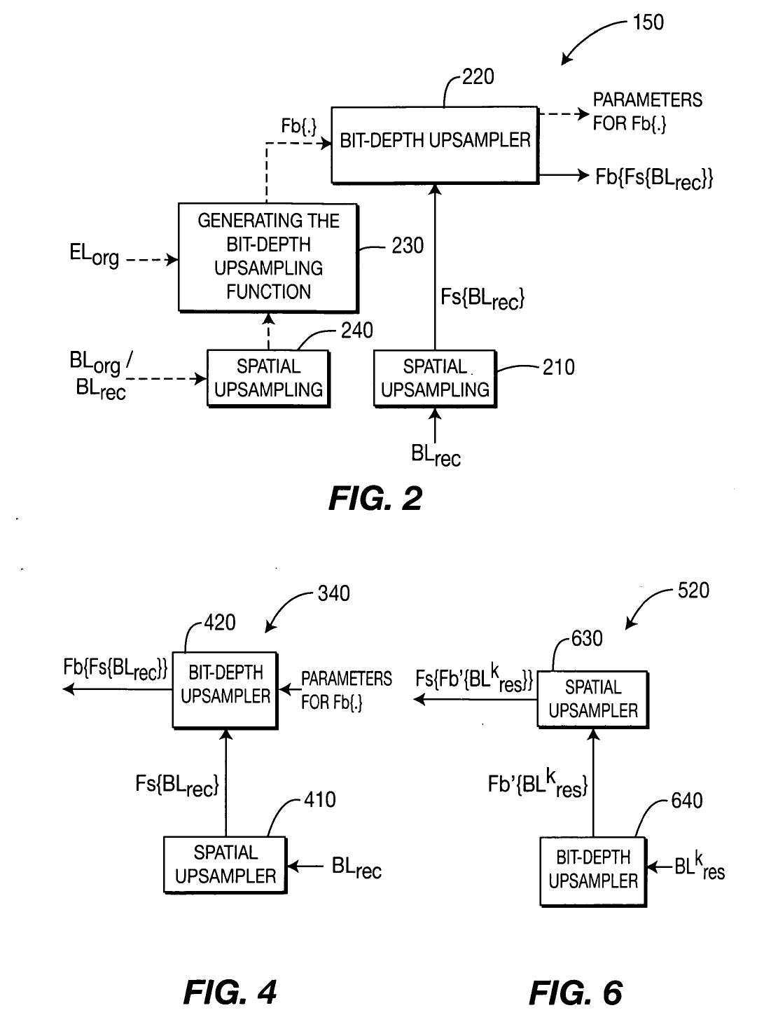

A non-limiting block diagram of the interlayer prediction module 150 is shown in FIG. 2. The module 150 first performs a spatial upsampling on the reconstructed base layer macroblock BL_{rec} by means of a spatial upsampler 210. Then, bit depth upsampling is performed using a bit-depth upsampler 220, by applying a bit-depth upsampling function Fb {.} on the spatial upsampled signal. The function Fb is generated by the module 230 using the original enhancement layer macroblock EL_{org} and a spatial upsampled signal generated by the spatial upsampler 240. The upsampler 240 may either process the original collocated base layer macroblock BL_{org} or the reconstructed base layer macro-block BL_{rec}. In one embodiment, the bit-depth upsampler 220 performs an inverse tone mapping. The outputs of the interlayer prediction model 150 include the prediction of the current enhancement layer and parameters of the bit-depth upsampling function Fb. The difference between the input source image 102 and the prediction is encoded.

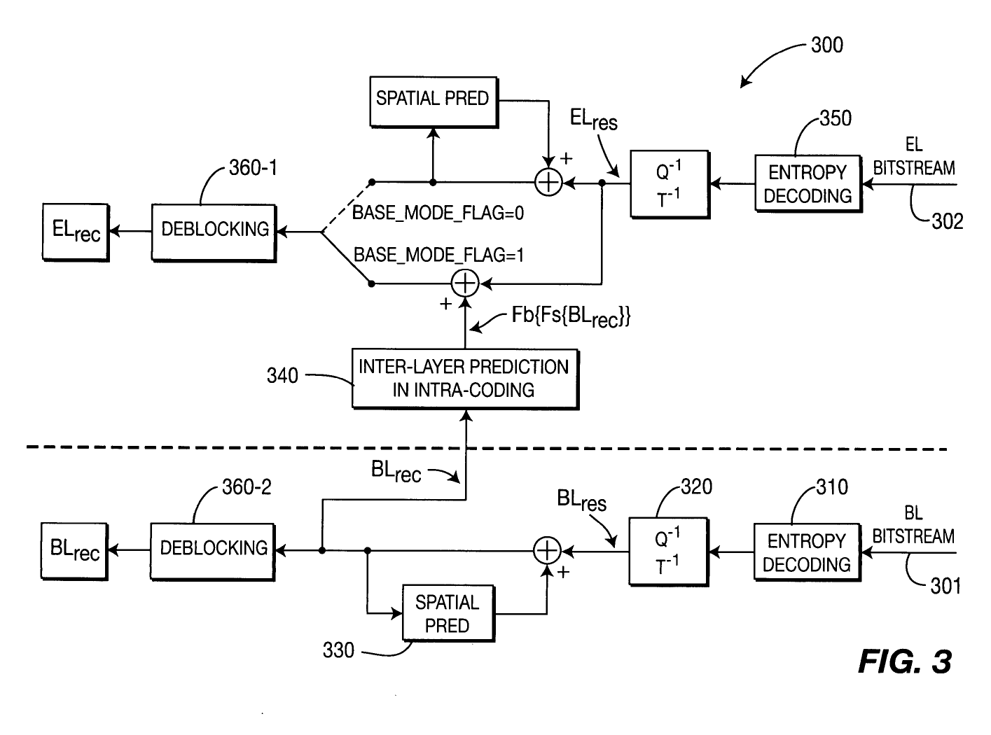

FIG. 3 shows a non-limiting block diagram of an implementation of a decoder 300 for decoding a combined bit depth and spatial scalability using an interlayer prediction. The decoder 300 is used when a collocated base layer macroblock is intra-coded. The decoder 300 receives a BL bit stream 301 and an EL base layer 302.

The input BL bit stream 301 is parsed by the entropy decoding unit 310 and then is inverse quantized and inverse transformed by the inverse quantizer and inverse transformer module 320 to output a reconstructed base layer residual signal BLᵣₑₛ. The spatial prediction of the current block, as computed by the spatial prediction module 330, is added to the output of module 320 to generate the reconstructed base layer collocated macroblock BL_{rec}.

The EL bit stream 302 may be decoded using the output of interlayer prediction unit 340. Otherwise, the decoding is performed based on the spatial prediction similar to the decoding of the BL bit stream 301. The interlayer prediction module 340 decodes the enhancement layer bit stream 302 using the BL_{rec} macroblock by performing spatial and bit depth upsampling. Deblocking is performed by deblocking modules 360-1 and 360-2.

A non-limiting block diagram of an implementation of the interlayer prediction module 340 is shown in FIG. 4.

The interlayer prediction module 340 is adapted to process macroblocks that are intra-coded. Specifically, first, the reconstructed base layer macro-block BL_{rec} is spatial upsampled using a spatial upsampler 410. Then, bit depth upsampling is performed, using a bit-depth upsampler 420, by applying a bit-depth upsampling function Fb on the spatial upsampled signal. The Fb function has the same parameters as that of the Fb function used to encode the enhancement layer. Components analogous to elements 230 and 240 in FIG. 2 may be used to determine the functions Fb and Fs in FIG. 4. The output of the interlayer prediction model 340 includes the prediction of the current enhancement layer. This output is added to the enhancement layer residual signal ELᵣₑₛ of FIG. 3.

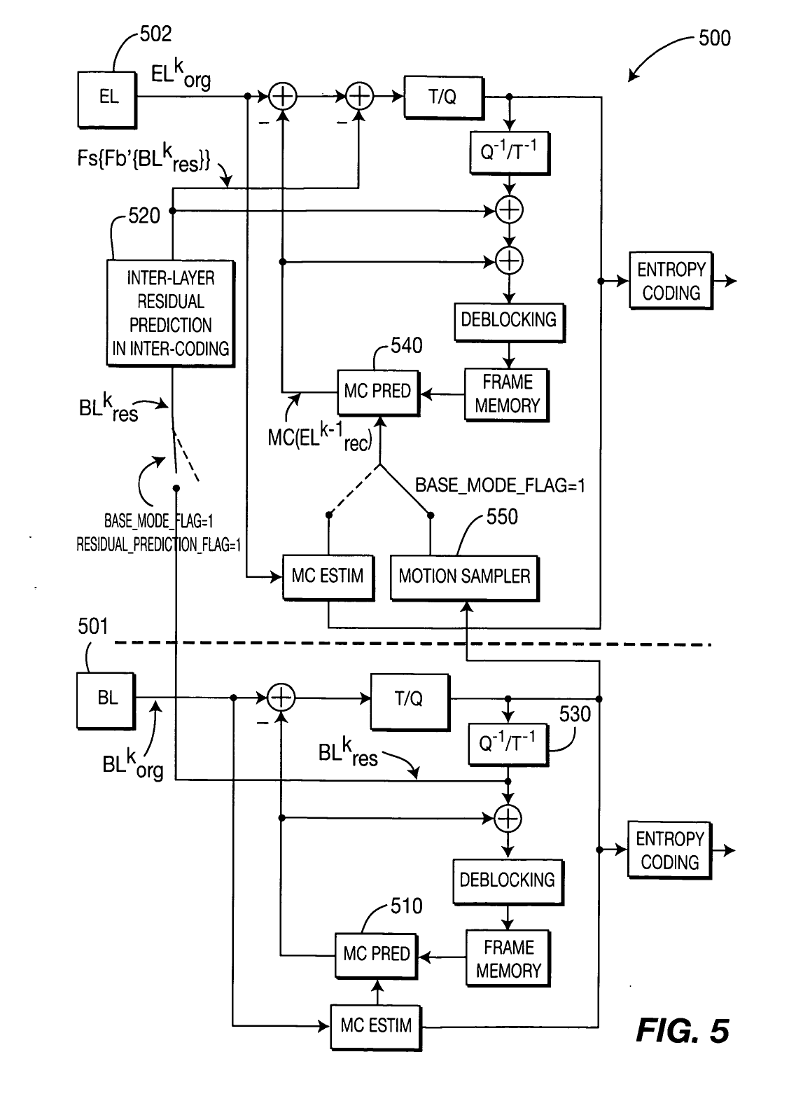

FIG. 5 shows a diagram of an implementation of an encoder 500 for encoding combined spatial and bit-depth scalability using an interlayer residual prediction. The encoder 500 is utilized when the reconstructed base layer macroblock is inter-coded. The encoding of a BL source image 501 is based on motion-compensation (MC) prediction provided by a MC prediction module 510. The encoding of an EL source image 502 may be performed by an interlayer prediction module 520 and a MC prediction signal generated by a MC prediction module 540. The module 540 processes a motion upsampled signal generated by the motion upsampler 550.

The interlayer residual prediction model 520 processes a reconstructed base layer residual signal BL^{k}ᵣₑₛ, (where k is a picture order count of the current picture). The residual signal BL^{k}ᵣₑₛ output by the inverse quantizer and transformer module 530.

As illustrated in FIG. 6 the interlayer residual prediction model 520 bit-depth upsamples the signal BL^{k}ᵣₑₛ using a bit-depth upsampler 640 which applies a bit-depth upsampling function Fb′ to generate the signal Fb′{BL^{k}ᵣₑₛ}. This signal is then spatial upsampled, using a spatial upsampler 630, to generate the residual prediction signal Fs{Fb′{BL^{k}ᵣₑₛ}}.

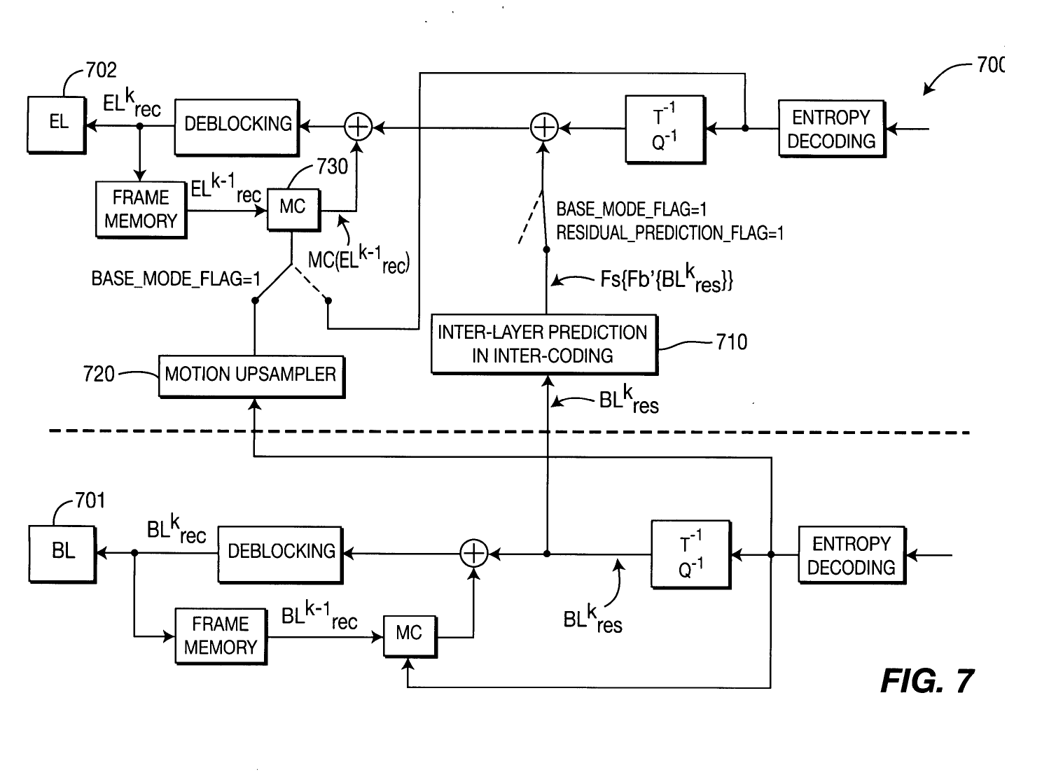

FIG. 7 shows a non-limiting block diagram of an implementation of a decoder 700 for decoding an inter-coded collocated base layer macroblock. The decoding resulting in an EL bit stream 702 is performed using an interlayer prediction residual module 710 by processing the reconstructed base layer residual signal BLᵣₑₛ In addition, a collocated base layer macroblock motion vector is motion upsampled, using a motion upsampler module 720. The upsampled motion vector from module 720 may be provided to a motion-compensated prediction module 730. Module 730 provides a motion compensated prediction for the current enhancement layer macroblock. The interlayer prediction residual module 710 performs spatial upsampling and bit-depth upsampling on the spatial upsampled signal to generate the residual prediction signal.

FIG. 7 also shows a string of elements for decoding a base layer, resulting in a BL bit stream 701. The string of elements for decoding the base layer includes well-known elements, including a motion-compensation prediction module 740.

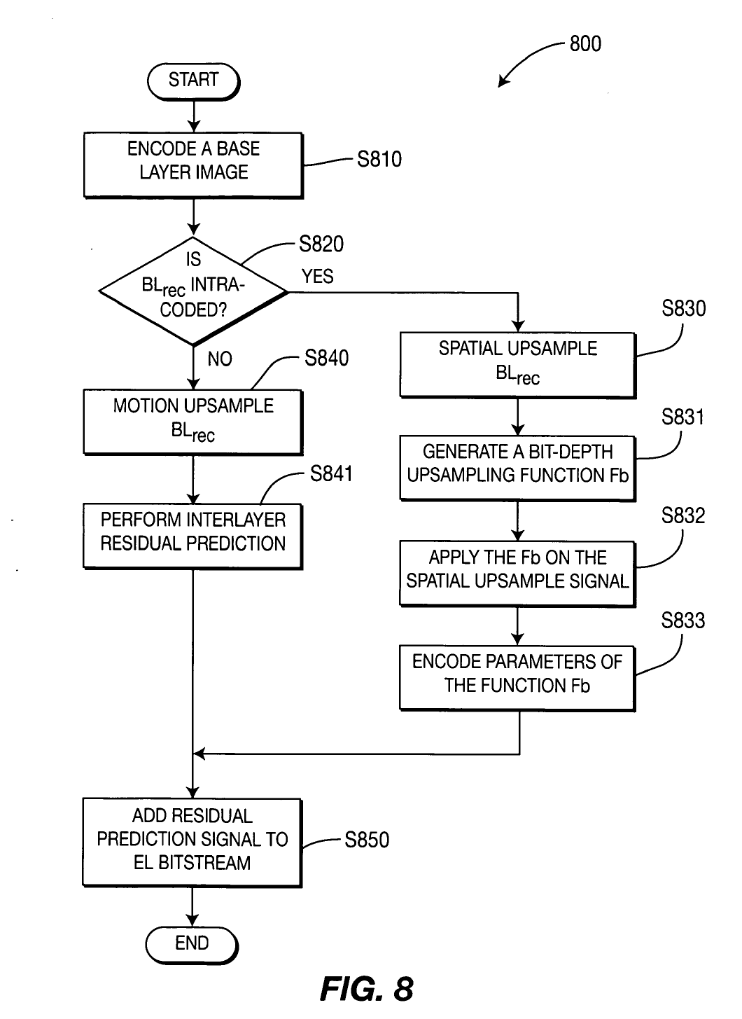

FIG. 8 shows a non-limiting flowchart 800 describing an encoding method for combined spatial and bit-depth scalability. The method uses at least two input source images of a base layer and an enhancement layer, which differ from both spatial resolution and color bit-depth, to encode an enhancement layer macroblock when the collocated base layer macroblock is either intra-coded or inter-coded. The method is based on an interlayer prediction that handles both spatial upsampling and bit-depth upsampling.

At S810 a base layer bit-stream is encoded. The base layer typically has low bit depth and low spatial resolution. At S820 it is checked if a collocated base layer macroblock is intra-coded, and if so execution continues with S830. Otherwise, execution proceeds to S840. At S830, a reconstructed base layer collocated macroblock BL_{rec} is spatial upsampled to generated a signal Fs{B_{Lrec}}. At S831, a bit-depth upsampling function Fb{.} is generated. At S832, the bit-depth upsampling function Fb{.} is applied on the spatial upsampled signal Fs{BL_{rec}} to generate the prediction of the current enhancement layer Fb{Fs{BL_{rec}}}. At S833, the parameters of the bit-depth upsampling function Fb{.} are encoded and the coded bits are inserted into the input EL bit stream. Then, execution proceeds to S850.

At S840 the collocated base layer macroblock motion vector is motion upsampled for a motion-compensated prediction of the current enhancement layer macroblock. Then, at S841, interlayer residual prediction is performed by spatial upsampling (Fs{.}) the reconstructed base layer residual signal BL^{K}ᵣₑₛ to generate the signal Fs{BL^{K}ᵣₑₛ}. The signal Fs{BL^{K}ᵣₑₛ} is then bit-depth upsampled Fb′{.}) to generate the residual prediction signal Fb′{Fs{BLᵣₑₛ}}. At S850, the residual prediction signal of the current enhancement layer, which is output either by S833 or S841, is added to the EL bit stream.

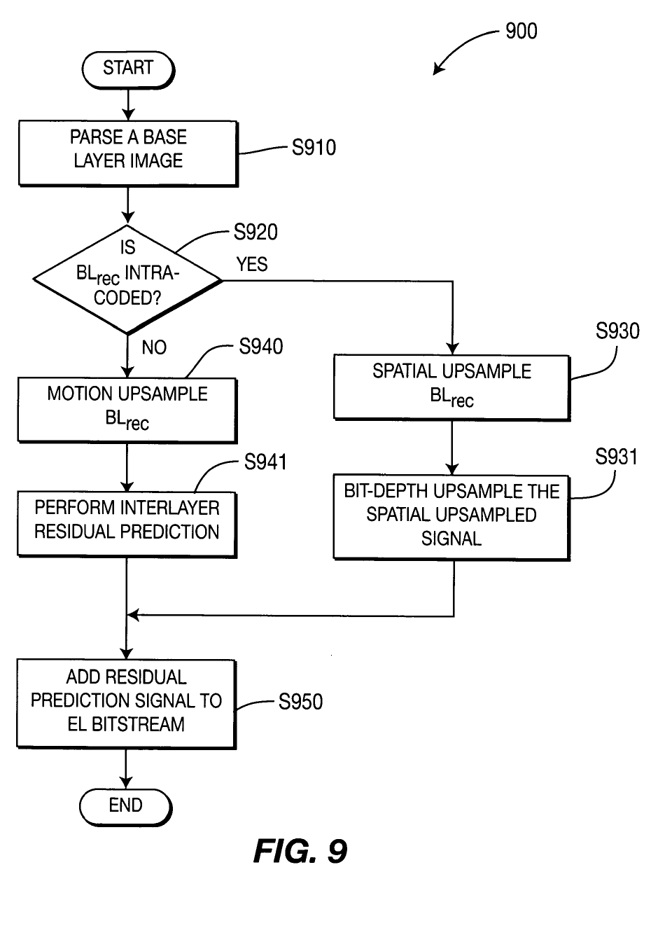

FIG. 9 shows a non-limiting flowchart 900 describing a decoding method for combined spatial and bit-depth scalability. The method uses at least two input bit streams of a base layer and an enhancement layer, which differ in both spatial resolution and color bit-depth, to decode an enhancement layer macroblock when the collocated base layer macroblock is either intra-coded or inter-coded. The method is based on an interlayer prediction that handles both spatial upsampling and bit-depth upsampling.

At S910 the base layer bit stream is parsed and parameters of the bit-depth upsampling function Fb{.} are extracted from the bit stream. At S920 a check is made to determine if a collocated base layer macroblock is intra-coded, and if so execution continues with S930. Otherwise, execution steps to S940.

At S930, the reconstructed base layer collocated macroblock BL_{rec} is spatial upsampled (Fs{.}) to generate a signal Fs{BL_{rec}}. At S931, the spatial upsampled signal Fs{BL_{rec}} is bit-depth upsampled (Fb{.}) to generate the prediction of the current enhancement layer Fb{Fs{BL_{rec}}}. Then, execution proceeds to S950.

At S940, the collocated base layer macroblock motion vector is motion upsampled for the motion-compensated prediction of the current enhancement layer macroblock. Then, at S941, an interlayer residual prediction is performed by spatial upsampling (Fs{.}) the reconstructed base layer residual signal BLᵣₑₛ to generate a signal Fs{BL^{k}ᵣₑₛ} and then bit-depth upsampling (Fb′{.}) the signal Fs{BL^{k}ᵣₑₛ} to generate the residual prediction signal Fb′{Fs{BL^{k}ᵣₑₛ}}. At S950, the residual prediction signal of the current enhancement layer is added to the bit stream of the enhancement layer.

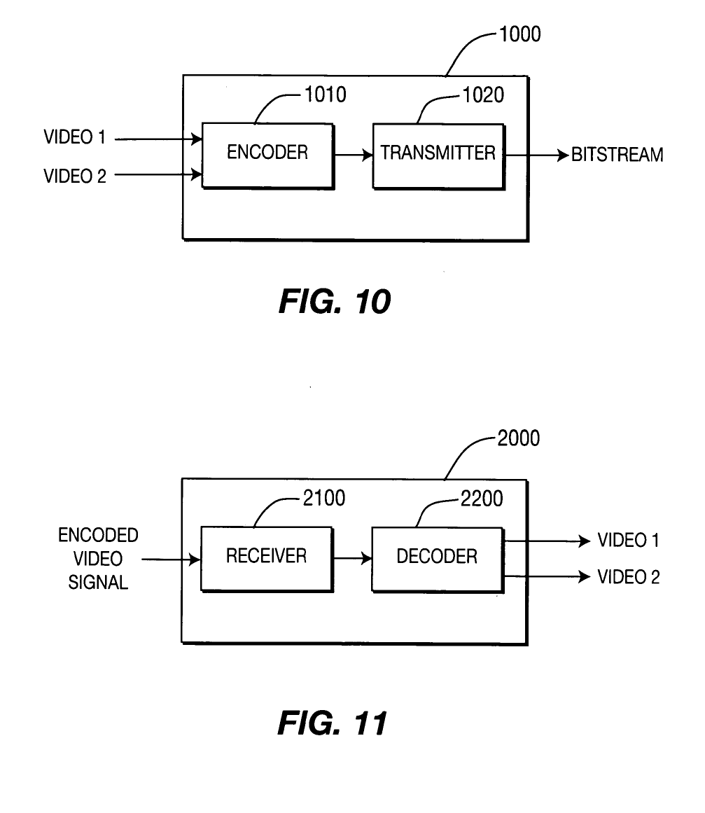

FIG. 10 shows a diagram of an implementation of a video transmission system 1000. The video transmission system 1000 may be, for example, a head-end or transmission system for transmitting a signal using any of a variety of media, such as, for example, satellite, cable, telephone-line, or terrestrial broadcast. The transmission may be provided over the Internet or some other network.

The video transmission system 1000 is capable of generating and delivering video contents with enhanced features, such as extended gamut and high dynamic compatible with different video receiver requirements. For example, the video contents can be displayed over home-theater devices that support enhanced features, CRT and flat panel displays supporting conventional features, and portable display devices supporting limited features. This is achieved by generating an encoded signal including a combined spatial and bit-depth scalability.

The video transmission system 1000 includes an encoder 1010 and a transmitter 1020 capable of transmitting the encoded signal. The encoder 1010 receives two video streams having different bit-depths and resolutions and generates an encoded signal having combined scalability properties. The encoder 1010 may be, for example, the encoder 100 or the encoder 500 which are described in detail above.

The transmitter 1020 may be, for example, adapted to transmit a program signal having a plurality of bitstreams representing encoded pictures. Typical transmitters perform functions such as, for example, one or more of providing error-correction coding, interleaving the data in the signal, randomizing the energy in the signal, and modulating the signal onto one or more carriers. The transmitter may include, or interface with, an antenna (not shown).

FIG. 11 shows a diagram of an implementation of a video receiving system 2000. The video receiving system 2000 may be configured to receive signals over a variety of media, such as, for example, satellite, cable, telephone-line, or terrestrial broadcast. The signals may be received over the Internet or some other network.

The video receiving system 2000 may be, for example, a cell-phone, a computer, a set-top box, a television, or other device that receives encoded video and provides, for example, decoded video for display to a user or for storage. Thus, the video receiving system 2000 may provide its output to, for example, a screen of a television, a computer monitor, a computer (for storage, processing, or display), or some other storage, processing, or display device.

The video receiving system 2000 is capable of receiving and processing video contents with enhanced features, such as extended gamut and high dynamic compatible with different video receiver requirements. For example, the video contents can be displayed over home-theater devices that support enhanced features, CRT and flat panel displays supporting conventional features, and portable display devices supporting limited features. This is achieved by receiving an encoded signal including a combined spatial and bit-depth scalability.

The video receiving system 2000 includes a receiver 2100 capable of receiving an encoded signal having combined spatial properties and a decoder 2200 capable of decoding the received signal.

The receiver 2100 may be, for example, adapted to receive a program signal having a plurality of bitstreams representing encoded pictures. Typical receivers perform functions such as, for example, one or more of receiving a modulated and encoded data signal, demodulating the data signal from one or more carriers, de-randomizing the energy in the signal, de-interleaving the data in the signal, and error-correction decoding the signal. The receiver 2100 may include, or interface with, an antenna (not shown).

The decoder 2200 outputs two video signals having different bit-depths and resolutions. The decoder 2200 may be, for example, the decoder 300 or 700 described in detail above. In a particular implementation the video receiving system 2000 is a set-top box connected to two different displays having different capabilities. In this particular implementation, the system 2000 provides each type of display with a video signal having properties supported by the display.

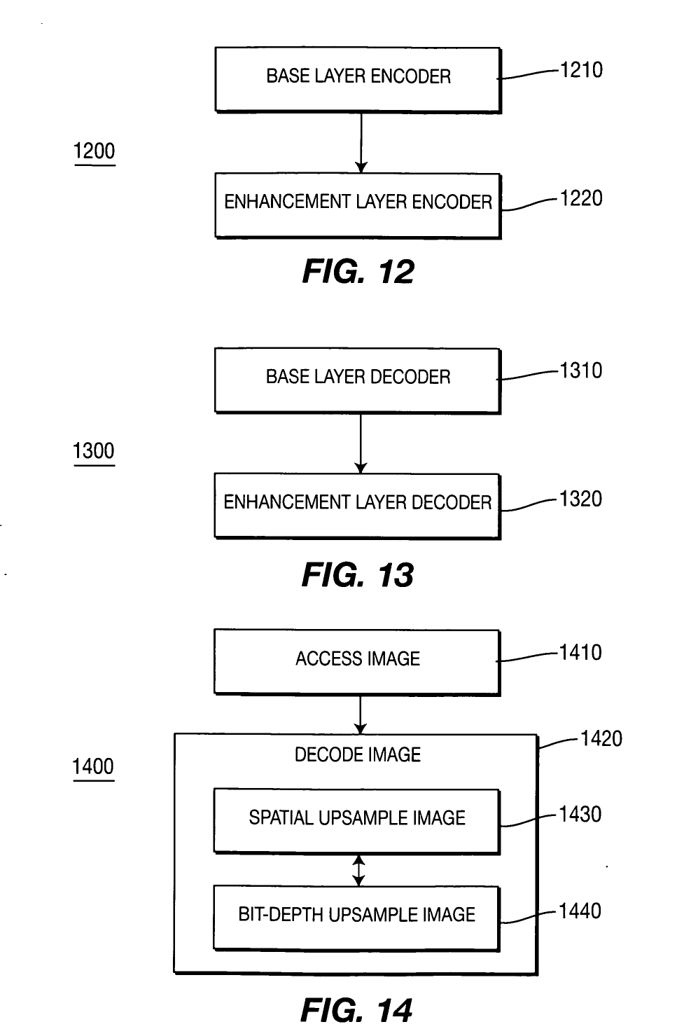

FIG. 12 shows another implementation of an encoder 1200. The encoder 1200 includes a base layer encoder 1210 coupled to an enhancement layer encoder 1220. The base layer encoder 1210 may operate according to, for example, the base layer encoding portion of encoders 100 or 500. The base layer encoding portions of encoders 100 and 500 generally includes the elements in the lower half of FIGS. 1 and 5 below the dashed lines. Analogously, the enhancement layer encoder 1220 may operate according to, for example, the enhancement layer encoding portion of encoders 100 or 500. The enhancement layer encoding portions of encoders 100 and 500 generally includes the elements in the upper half of FIGS. 1 and 5 above the dashed lines.

FIG. 13 shows another implementation of a decoder 1300. The decoder 1300 includes a base layer decoder 1310 coupled to an enhancement layer decoder 1320. The base layer decoder 1310 may operate according to, for example, the base layer decoding portion of decoders 300 or 700. The base layer decoding portions of decoders 300 and 700 generally includes the elements in the lower half of FIGS. 3 and 7 below the dashed lines. Analogously, the enhancement layer decoder 1320 may operate according to, for example, the enhancement layer decoding portion of decoders 300 or 700. The enhancement layer decoding portions of decoders 300 and 700 generally includes the elements in the upper half of FIGS. 3 and 7 above the dashed lines.

FIG. 14 provides a process 1400 for decoding a received data stream providing data that is both spatial and bit-depth scalable and spatial scalable. The process 1400 includes accessing a portion of an encoded image (1410), and decoding the accessed portion (1420). The portion may be, for example, an enhancement layer for a picture, frame, or layer.

The decoding operation 1420 includes performing spatial upsampling of the accessed portion to increase the spatial resolution of the accessed portion (1430). The spatial upsampling may change the accessed portion from standard definition (SD) to high definition (HD), for example.

The decoding operation 1420 includes performing bit-depth upsampling of the accessed portion to increase the bit-depth resolution of the accessed portion (1440). The bit-depth upsampling may change the accessed portion from 8-bits to 10-bits, for example.

The bit-depth upsampling (1440) may be performed before or after the spatial upsampling (1430). In a particular implementation, the bit-depth upsampling is performed after the spatial upsampling, and changes the accessed portion from 8-bit SD to 10-bit HD. The bit-depth upsampling in various implementations uses inverse tone mapping, which generally provides a non-linear result. Various implementations apply non-linear inverse tone mapping, after spatial upsampling.

The process 1400 may be performed, for example, using the enhancement layer decoding portions of decoders 300 or 700. Further, the spatial and bit-depth upsampling may be performed by, for example, the inter-layer prediction modules 340 (see FIG. 3 and 4) or 710 (see FIG. 7). As should be clear, the process 1400 may be performed in the context of either intra-coding or inter-coding.

Further, the process 1400 may be performed by an encoder, such as, for example, the encoders 100 or 500. In particular, the process 1400 may be performed, for example, using the enhancement layer encoding portions of encoders 100 or 500. Further, the spatial and bit-depth upsampling may be performed by, for example, the inter-layer prediction modules 150 (see FIGS. 1 and 2) or 520 (see FIGS. 5 and 6).

The implementations described herein may be implemented in, for example, a method or a process, an apparatus, or a software program. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of equipment include video coders, video decoders, video codecs, web servers, set-top boxes, laptops, personal computers, cell phones, PDAs, and other communication devices. As should be clear, the equipment may be mobile and even installed in a mobile vehicle.

Additionally, the methods may be implemented by instructions being performed by a processor, and such instructions may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a computer readable medium having instructions for carrying out a process.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

1. A method comprising:
encoding a source image of a base layer macroblock; and
encoding a source image of an enhancement layer macroblock by performing an inter-layer prediction,
wherein the source image of the base layer and the source image of the enhancement layer differ from each other both in spatial resolution and color bit-depth.

2. The method of claim 1, further comprising:
checking if a collocated base layer macroblock is either intra-coded or inter-coded.

3. The method of claim 2, wherein the inter-layer prediction for encoding the enhancement layer macroblock, for which the collocated base layer macroblock is intra-coded, comprises:
spatial upsampling (Fs{.}) the reconstructed base layer collocated macroblock BL_{rec} to generate the signal Fs{BL_{rec}};
generating a bit-depth upsampling function Fb{.};
bit-depth upsampling (Fb{.}) the spatial upsampled signal Fs{BL_{rec}} to generate a prediction of a current enhancement layer Fb{Fs{BL_{rec}}};
encoding the parameters of the bit-depth upsampling function Fb{.}; and
inserting the coded bits into the bitstream.

4. The method of claim 3, wherein performing the bit-depth upsampling function Fb{.} is determined according to at least:
an original enhancement layer macroblock EL_{org} and a spatial upsampled signal Fs{BL_{org}}, wherein BL_{org} is an original collocated base layer macroblock; or
an original enhancement layer macroblock EL_{org} and a spatial upsampled signal Fs{BL_{rec}}.

5. The method of claim 3, wherein bit-depth upsampling comprises inverse tone mapping.

6. The method of claim 2, wherein performing the inter-layer prediction for encoding the enhancement layer macroblock, for which the collocated base layer macroblock is inter-coded, further comprises:
motion upsampling a collocated base layer macroblock motion vector for a motion-compensated prediction of a current enhancement layer macroblock; and
performing inter-layer residual prediction.

7. The method of claim 6, wherein performing the inter-layer residual prediction, further comprising:
bit-depth upsampling (Fb′{.}) a reconstructed base layer residual signal BL^{k}ᵣₑₛ to generate a signal Fb′{BL^{k}ᵣₑₛ}, wherein k is a picture order count of a current picture; and
spatial upsampling (Fs{.}) the bit-depth upsampled signal Fb′{BL^{k}ᵣₑₛ} to generate a residual prediction signal Fs{Fb′{BL^{k}ᵣₑₛ}}.

8. The method of claim 7, wherein bit-depth upsampling comprises inverse tone mapping.

9. The method of claim 6, wherein performing the inter-layer residual prediction further comprises:
spatial upsampling (Fs{.}) a reconstructed base layer residual signal BL^{k}ᵣₑₛ to generate a signal Fs{BL^{k}ᵣₑₛ}, wherein k is a picture order count of a current picture;
bit-depth upsampling (Fb′{.}) the signal Fs{BL^{k}ᵣₑₛ} to generate a residual prediction signal Fb′{Fs{BL^{k}ᵣₑₛ}}.

10. The method of claim 9, wherein bit-depth upsampling comprises inverse tone mapping.

11. A method comprising:
accessing a portion of an encoded image; and
decoding the accessed portion, wherein the decoding includes:
performing spatial upsampling of the accessed portion to increase the spatial resolution of the accessed portion; and
performing bit-depth upsampling of the accessed portion to increase the bit-depth resolution of the accessed portion.

12. The method of claim 11, wherein performing the bit-depth upsampling comprises performing inverse tone mapping.

13. The method of claim 11, wherein the bit-depth upsampling is performed after the spatial upsampling is performed.

14. The method of claim 11, wherein decoding the accessed portion comprises:
decoding a source image of a base layer macroblock; and
decoding a source image of an enhancement layer macroblock by performing an inter-layer prediction,
wherein the source image of the base layer and the source image of the enhancement layer differ from each other both in spatial resolution and color bit-depth.

15. The method of claim 14, further comprising:
checking if a collocated base layer macroblock, which is collocated with the enhancement layer macroblock, is intra-coded or inter-coded.

16. The method of claim 15, wherein:
performing the inter-layer prediction for decoding the enhancement layer macroblock, for which the collocated base layer macroblock is intra-coded, comprises the spatial upsampling and the bit-depth upsampling,
the spatial upsampling comprises spatial upsampling (Fs{.}) a reconstructed base layer collocated macroblock BL_{rec} to generate the signal Fs{BL_{rec}}, and
the bit-depth upsampling comprises bit-depth upsampling (Fb{.}) the spatial upsampled signal Fs{BL_{rec}} to generate a prediction of a current enhancement layer Fb{Fs{BL_{rec}}}.

17. The method of claim 15, wherein performing the inter-layer prediction for decoding the enhancement layer macroblock, for which the collocated base layer macroblock is inter-coded, comprises:
motion upsampling a collocated base layer macroblock motion vector for a motion-compensated prediction of a current enhancement layer macroblock; and
performing an inter-layer residual prediction.

18. The method of claim 17, wherein:
performing the inter-layer residual prediction comprises the spatial upsampling and the bit-depth upsampling,
the bit-depth upsampling comprises bit-depth upsampling (Fb′{.}) a reconstructed base layer residual signal BLₖ^{res} to generate a signal Fb′{BL^{k}ᵣₑₛ}, wherein k is to a picture order count of a current picture, and
the spatial upsampling comprises spatial upsampling (Fs{.}) a bit-depth upsampled signal Fb′{BL^{k}ᵣₑₛ} to generate a residual prediction signal Fs{Fb′{BL^{k}ᵣₑₛ}}.

19. The method of claim 17, wherein:
performing the inter-layer residual prediction comprises the spatial upsampling and the bit-depth upsampling,
the spatial upsampling comprises spatial upsampling (Fs{.}) a reconstructed base layer residual signal BL^{k}ᵣₑₛ to generate the signal Fs{BL^{k}ᵣₑₛ}, wherein k is to a picture order count of a current picture, and
the bit-depth upsampling comprises bit-depth upsampling (Fb′{.}) a signal Fs{BL^{k}ᵣₑₛ} to generate a residual prediction signal Fb′{Fs{BL^{k}ᵣₑₛ}}.

20. An apparatus comprising:
a base layer encoder for encoding a source image of a base layer macroblock; and
an enhancement layer encoder for encoding a source image of an enhancement layer macroblock by performing an inter-layer prediction,
wherein the source image of the base layer and the source image of the enhancement layer differ from each other both in spatial resolution and color bit-depth.

21. The apparatus of claim 20, wherein:
the base layer encoder comprises a spatial prediction module (140) for encoding a source image of a base layer macroblock, and
the enhancement layer encoder comprises an inter-layer prediction module for encoding a source image of an enhancement layer macroblock of which a collocated base layer macroblock is intra-coded,
wherein the source image of the base layer and the source image of the enhancement layer differ from each other both in spatial resolution and color bit-depth.

22. The apparatus of claim 20, wherein:
the base layer encoder comprises a motion-compensation prediction module for encoding a source image of a base layer macroblock, and
the enhancement layer encoder comprises:
a motion upsampler or a motion upsampling a collocated base layer macroblock motion vector for motion-compensated prediction of a current enhancement layer macroblock; and
an inter-layer residual prediction module for performing an inter-layer residual prediction,
wherein the source image of the base layer and the source image of the enhancement layer differ from each other both in spatial resolution and color bit-depth.

23. An apparatus comprising:
a base layer decoder for decoding a source image of a base layer macroblock; and
an enhancement layer decoder for decoding a source image of an enhancement layer macroblock by performing an inter-layer prediction,
wherein the source image of the base layer and the source image of the enhancement layer differ from each other both in spatial resolution and color bit-depth.

24. The apparatus of claim 23 wherein:
the base layer decoder comprises a spatial prediction module for decoding a source image of a base layer macroblock, and
the enhancement layer decoder comprises an inter-layer prediction module for decoding a source image of an enhancement layer macroblock of which a collocated base layer macroblock is intra-coded,
wherein the source image of the base layer and the source image of the enhancement layer differ from each other both in spatial resolution and color bit-depth.

25. The apparatus of claim 23 wherein:
the base layer decoder comprises a motion-compensation prediction module for decoding a source image of a base layer macroblock, and
the enhancement layer decoder comprises:
a motion upsampler for motion upsampling a collocated base layer macroblock motion vector for a motion-compensated prediction of a current enhancement layer macroblock; and
an inter-layer residual prediction module (740) for performing an inter-layer residual prediction,
wherein the source image of the base layer and the source image of the enhancement layer differ from each other both in spatial resolution and color bit-depth.

26. A processor-readable medium having stored thereon instructions for causing a processor to perform at least the following:
encoding a source image of a base layer macroblock; and
encoding a source image of an enhancement layer macroblock by performing an inter-layer prediction,
wherein the source image of the base layer and the source image of the enhancement layer differ from each other both in spatial resolution and color bit-depth.

27. A processor-readable medium having stored thereon instructions for causing a processor to perform at least the following:
decoding a source image of a base layer macroblock; and
decoding a source image of an enhancement layer macroblock by performing an inter-layer prediction, wherein the source image of the base layer and the source image of the enhancement layer differ from each other both in spatial resolution and color bit-depth.

28. A signal formatted to comprise:
a base layer bitstream; and
an enhancement layer bitstream, wherein the base layer bitstream and the enhancement layer bitstream differ from each other both in spatial resolution and color bit-depth.

29. A processor-readable medium comprising data formatted to include:
a base layer bitstream; and
an enhancement layer bitstream, wherein the base layer bitstream and the enhancement layer bitstream differ from each other both in spatial resolution and color bit-depth.

30. A video transmission system comprising:
an encoder configured to perform the following:
encoding a source image of a base layer macroblock; and
encoding a source image of an enhancement layer macroblock by performing an inter-layer prediction,
wherein the source image of the base layer and the source image of the enhancement layer differ from each other both in spatial resolution and color bit-depth; and
a transmitter for modulating and transmitting the encoded base layer macroblock and the encoded enhancement layer macroblock.

31. A video receiving system comprising:
a receiver for receiving an encoded signal having combined spatial properties and demodulating the received signal; and
an decoder configured to perform at least the following:
accessing a portion of an encoded image from the demodulated encoded signal;
performing spatial upsampling of the accessed portion to increase the spatial resolution of the accessed portion; and
performing bit-depth upsampling of the accessed portion to increase the bit-depth resolution of the accessed portion.

32. An apparatus comprising:
means for encoding a source image of a base layer macroblock; and
means for encoding a source image of an enhancement layer macroblock by performing an inter-layer prediction,
wherein the source image of the base layer and the source image of the enhancement layer differ from each other both in spatial resolution and color bit-depth.

33. An apparatus comprising:
means for decoding a source image of a base layer macroblock; and
means for decoding a source image of an enhancement layer macroblock by performing an inter-layer prediction,
wherein the source image of the base layer and the source image of the enhancement layer differ from each other both in spatial resolution and color bit-depth.
